(19) United States
(12) Patent Application Publication
(10) Pub. No.: US 2006/0038329 A1
(43) Pub. Date: Feb. 23, 2006

(54) Device for damping pitching movements of a vehicle body

(76) Inventor: Darko Meljnikov, Leinfelden-Echterdingen (DE)

Correspondence Address: KLAUS J. BACH, 4407 TWIN OAKS DRIVE, MURRYSVILLE, PA, 15668, US

(21) Appl. No.: 11/253,238

(22) Filed: Oct. 18, 2005

Related U.S. Application Data
(63) Continuation-in-part of application No. PCT/EP03/14684, filed on Dec. 20, 2003.

(30) Foreign Application Priority Data
Feb. 15, 2003 (DE) 103 06 364.1

(51) Int. Cl. B60G 17/00

(52) U.S. Cl. 267/64.16

(57) ABSTRACT

In a device for reducing pitching movements of a vehicle body, with two hydraulic vibration dampers of vehicle wheels interconnected by a balancing device via hydraulic lines wherein the balancing device has various chambers of variable size with a first separating piston delimiting a first chamber filled with a compressible medium, a second and a third chamber separated by a separating piston and filled each with hydraulic fluid, the second and the third chamber being connected each to a different vibration damper via one of the hydraulic lines, and bores with valves disposed in the separating piston via which the second and third chambers can communicate with one another, a bypass is provided which extends parallel to the valve bores in the separation piston and interconnects the second and the third chambers.

This is a Continuation-In-Part Application of International Application PCT/EP2003/014684 filed Dec. 20, 2003 and claiming the priority of German application 103 06 364.1 filed Feb. 15, 2003.

### BACKGROUND OF THE INVENTION

The invention relates to a device for damping pitching movements of a vehicle body comprising two hydraulic vibration dampers.

A device of this type is known from the Audi RS 6. The device used in the Audi damps the pitching of a vehicle body in a simple way by means of the crosswise interconnection of the spring strut dampers of the two vehicle axles. On the other hand the vehicle suffers losses of comfort in the event of the one-sided compression of a vehicle wheel, such as occurs, for example, when a vehicle drives over an individual obstacle, for example a manhole cover.

EP 0 980 774 A2 discloses devices for damping pitching in a vehicle body, in which in each case two vibration dampers are connected to a balancing device via hydraulic lines. In this case, the balancing device has two pistons which are connected fixedly to one another via a piston rod and which delimit three chambers of variable volume. Two of these chambers are connected to the vibration dampers via the hydraulic lines.

FR A 1323746 discloses a brake master cylinder, in which a separating piston with valves is arranged between the first brake chamber and the second brake chamber, the valves having passages with variable flow cross sections, in order, where appropriate, to damp oscillations of the hydraulic medium between the first and second brake chamber. However, technical functioning of a brake master cylinder is not comparable to a balancing device between two vibration dampers.

It is the object of the present invention to provide a device for damping pitching movements of a vehicle body, so as to improve the degree of comfort in the event of excitations to vibration on individual wheels.

### SUMMARY OF THE INVENTION

In a device for reducing pitching movements of a vehicle body, with two hydraulic vibration dampers of vehicle wheels interconnected by a balancing device via hydraulic lines wherein the balancing device has various chambers of variable size with a first separating piston delimiting a first chamber filled with a compressible medium, a second and a third chamber separated by a separating piston and filled each with hydraulic fluid, the second and the third chamber being connected each to a different vibration damper via one of the hydraulic lines, and bores with valves disposed in the separating piston via which the second and third chambers can communicate with one another, a bypass is provided which extends parallel to the valve bores in the separation piston and interconnects the second and the third chambers.

The bypass forms an operative communication path between the vibration dampers which is independent of the valve. It is possible, by virtue of the structural design of the bypass, to configure the damped exchange of hydraulic fluid between the vibration dampers in such a way that, in the event of a one-sided excitation to vibration, for example caused when a vehicle drives over a manhole cover, fewer stroke movements, which have an adverse effect on comfort, are introduced into the vehicle body. According to the invention, either the bypass is formed in the same separating piston in which the damping valve or damping valves is or are also contained or the bypass extends in a piston rod connected to the separating piston. The device can thereby be relatively small.

In one embodiment of the invention, the bypass includes a throttle valve with a flow cross section which can be controlled as function of certain parameters. The parameters used may in this case be, for example, the driving speed, steering angle, steering angle change, speed and transverse acceleration of the vehicle and the temperature of the hydraulic fluid in the vibration dampers.

In another embodiment of the invention, the bypass includes a pressure difference piston which is mounted axially movably in a bypass chamber. By the action of pressure upon one end face of the pressure difference piston by means of hydraulic fluid from one vibration damper, the pressure difference piston can be displaced at most by a predetermined travel distance before it comes to bear, in a damped fashion, against an end wall of the bypass chamber. The volume of hydraulic fluid displaced by the piston enters the other vibration damper connected to the device according to the invention. By the design of the damping means provided for the damped bearing of the pressure difference piston against an end wall of the bypass chamber, the transition to the greater damping action implemented by means of mechanical valves can be influenced.

An exemplary embodiment of the device according to the invention will be described in more detail below with reference to the accompanying drawings:

### BRIEF DESCRIPTION OF THE DRAWINGS

FIG. 1 is a diagrammatic overview of the device according to the invention, and

FIG. 2 shows a detail of a longitudinal section through the balancing device.

### DESCRIPTION OF A PARTICULAR EMBODIMENT OF THE INVENTION

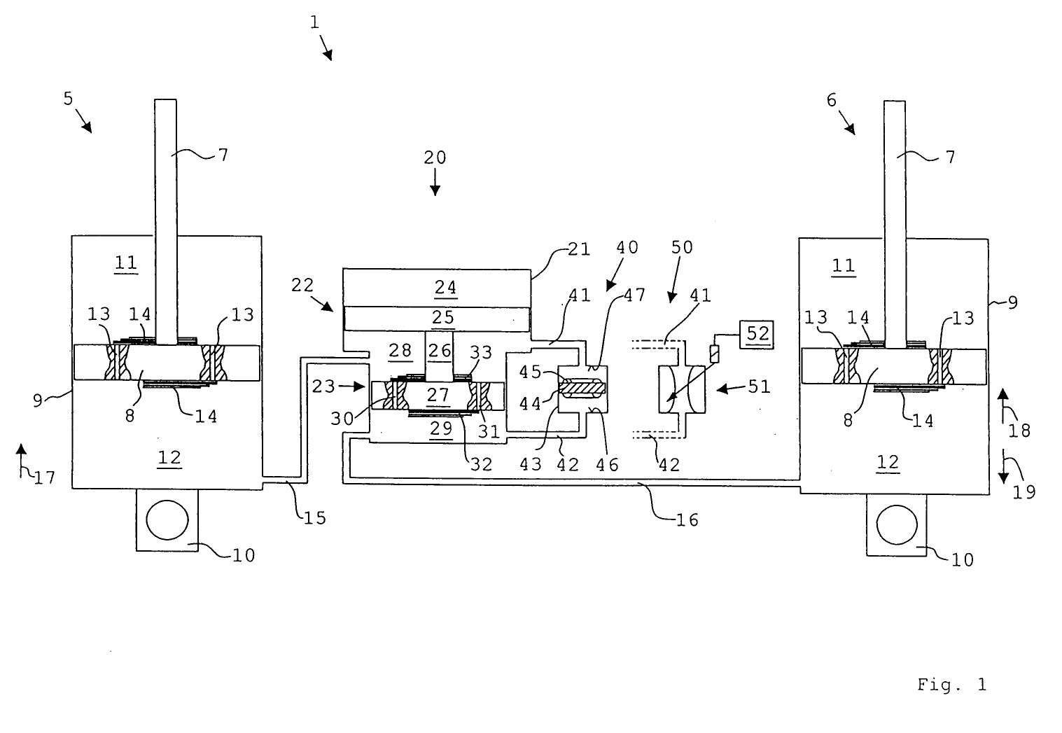

FIG. 1 illustrates the device 1 according to the invention diagrammatically. The vibration dampers 5, 6 illustrated there are connected to two vehicle wheels running in spaced tracks. They are constructed basically in the same way and each has a piston 8 which is connected to a piston rod 7 and is guided in each case in a cylinder 9. The cylinder 9 is connected via a mounting structure 10 to a vehicle wheel not illustrated in detail. The piston rod 7 is mounted on the vehicle body in a conventional manner which is, likewise not illustrated.

The piston 8 divides the cylinder 9 into two chambers 11, 12 which are filled with hydraulic fluid. The two chambers 11 are 12 in communication with each other via bores 13 in the piston 8. The orifices, facing the chambers 11, 12, of the bores 13 are in this case closed so that they can be opened, at least partially, by means of valves 14, for example in the form of leaf spring assemblies.

The lower chambers 12 of the vibration dampers 5, 6 are connected to a balancing device 20 via lines 15, 16. The housing 21 of the balancing device 20 has two essentially cylindrical housing parts 22, 23 which are connected axially to one another and possess different outside and inside diameters.

The upper housing part 22, illustrated in FIG. 1, delimits, together with a first separating piston 25, a first chamber 24. The first separating piston 25 is mounted axially displaceably in the upper housing part 22 and is connected non-positively to, that is it abuts, one end of a piston rod 26 extending coaxially with respect to the two housing parts 22, 23. At the other end the piston rod 26 is fastened to a second separating piston 27 which, together with the first separating piston 25 and the housing 21, delimits a second chamber 28. In this case, the second chamber 28 has both a portion which is delimited by the upper housing part 22 and a portion which is delimited by the lower housing part 23 which has the smaller inside diameter.

On the side of the second separating piston 27 which is disposed opposite the second chamber 28, a third chamber 29 is delimited by the lower housing part 23 and the second separating piston 27. Via bores 30, 31 in the second separating piston 27, this third chamber 29 is connected to the second chamber 28. The orifices, facing the chambers 28, 29, of the bores 30, 31 are in this case closed but can at least partially be opened by valves 32, 33, for example in the form of spring assemblies.

The lower chamber 12 of the vibration damper 5 is connected to the second chamber 28 of the balancing device 20 via the line 15. The lower chamber 12 of the vibration damper 6 is connected to the third chamber 29 of the balancing device 20 via the line 16.

A bypass 40 extends between the second and third chambers 28, 29 parallel to the second separating piston 27. The bypass 40 includes an upper line 41, which is connected, on one hand, to the second chamber 28 and, on the other hand, to the upper end of a bypass chamber 43, and a lower line 42 which connects the lower end of the bypass chamber 43 to the third chamber 29. A pressure difference piston 44 is mounted axially displaceably in the bypass chamber 43. The axial end faces of the pressure difference piston 44 are provided with damping elements 45 which act as stop buffers when the pressure difference piston 44 comes to bear against one of the two end walls 46, 47 of the bypass chamber 43.

FIG. 1 illustrates, on the right next to the bypass 40, a further bypass variant 50 depicted in part only by broken lines. This bypass variant 50 differs from the abovementioned bypass 40 in that, instead of the pressure difference piston 44, a variable throttle 51 is provided in the form of a proportional valve which, for example, can be activated electromagnetically. The variable throttle 51 may be a single-stage or multistage switching valve. This bypass variant 50 may be arranged both in place of the bypass 40 and parallel to the latter or in series with the latter in the balancing device 20.

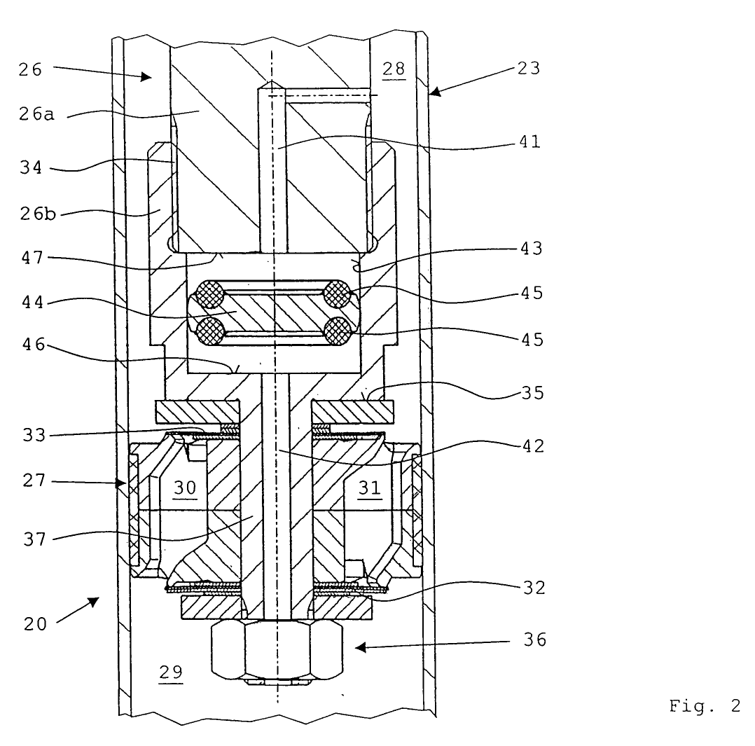

FIG. 2 illustrates a detail of a longitudinal section through the balancing device 20. In this case, the latter is designed as a single-tube damper. In principle, however, a multi-tube damper, for example a two-tube damper, may also be used.

Arranged coaxially with respect to the lower housing part 23 is the piston rod 26. The latter comprises two parts 26a, 26b, the two piston rod parts 26a, 26b, which are arranged coaxially with respect to one another being screwed to one another by a thread 34.

1 The lower end face of the upper piston rod element 26a in this case forms the upper end wall 47 of the bypass chamber 43 which is surrounded predominantly by the lower piston rod part 26b and in which the pressure difference piston 44 is axially movably disposed.

The lower piston rod element 26b is provided at its lower end with an axial extension 37 on which the second separating piston 27 is mounted between an axial stop 35 and a screw connection 36.

The second separating piston 27 separates the second chamber 28 from the third chamber 29. These are, however, connectable to one another via the bores 30, 31 in the second separating piston 27. In a normal position of the vibration dampers 5, 6, the bores 30, 31 are closed in each case at an orifice by means of valves 32, 33 in the form of spring assemblies.

The third chamber 29 is connected to the lower region of the bypass chamber 43 via a longitudinal bore 42 in the lower piston rod element 26b. The upper region of the bypass chamber 43 is likewise connected to the second chamber 28 via a longitudinal and a transverse bore 41. The bypass 40, illustrated outside the housing 21 in FIG. 1, is thus implemented, in FIG. 2, inside the piston rod 26. Such a bypass 40 could likewise be implemented in a further bore extending parallel to the bores 30, 31, in the second separating piston 27.

In one possible embodiment of the invention, the second separating piston 27 is mounted with some axial movability between a stop 35 and the screw connection 36 at the lower end of the piston rod 26. In this case, for example, the piston 27 and the valves 32, 33 are fixedly connected to a carrier sleeve mounted axially movably on the narrowing 37. As a result, the second separating piston 27 acts in the bypass 40 in the same way as the pressure difference piston 44, in that hydraulic fluid flows through the bores 30, 31 and valves 32, 33 only after the second separating piston has come to bear against the stop 35 or against the screw connection 36.

The device according to the invention for damping pitching of a vehicle body operates as follows:

In the event of the simultaneous compression of both vehicle wheels assigned to the vibration dampers 5, 6, a relative displacement of the cylinders 9 with respect to the piston 8 takes place in the direction of the arrows 17, 18.

This brings about a pressure rise in the lower chambers 12, which is reduced by the overflow of hydraulic fluid from the lower chambers 12 into the upper chambers 11 via the bores 13 in the pistons 8. This overflow takes place in a throttled manner, since both the bores 13 and the valves 14 constitute flow resistances through the pistons 8.

As a result of the movement of the piston rods 7 into the upper chambers 11 that is, into the cylinder 9 of the vibration dampers 5, 6, a certain volume is displaced there, so that hydraulic fluid is displaced from the lower chambers 12 through the lines 15, 16 into the second chamber 28 or third chamber 29 of the balancing device 20. As a result of the increase in volume due to the additional hydraulic fluid, the separating pistons 25, 27, which are connected to one another via the piston rod 26, are displaced in the chambers 28, 29 in the direction of the first chamber 24.

A compressible medium, for example a compressible gas, which acts as a spring, is located in the first chamber 24. As a result of the axial displacement of the separating pistons 25, 27 in the direction of the first chamber 24, the medium therein is compressed until a pressure equilibrium is established in the chambers 24, 28, 29.

As result of the identical increase in volume in the second and third chamber 28, 29 in the event of an equal-sided compression of the vehicle wheels, the pressure in the two chambers 28, 29 also changes uniformly. This pressure increase acts uniformly on both sides of the pressure difference piston 44, so that the position of the latter in the bypass chamber remains unchanged.

In the event of a simultaneous rebound of the vehicle wheels as a result of the vacuum occurring in the lower chambers 12 of the vibration dampers 5, 6, hydraulic fluid flows out of the chambers 28, 29 of the balancing device 20 into these lower chambers 12, the separating pistons 25, 27 coupled to one another via the piston rod 26 being pressed downward by the expanding medium in the first chamber 24. The position of the pressure difference piston 44 in the bypass chamber 40 is in this case likewise unchanged.

In the event of the simultaneous compression and rebound of the vehicle wheels connected to one another via the device 1 according to the invention, the vibration dampers 5, 6 therefore behave in the same way as vibration dampers 5, 6 not connected to one another. Only the separating pistons, which are usual in the cylinders of conventional vibration dampers and which separate the compressible medium from the hydraulic fluid, are combined in the balancing device 20.

The action of the device according to the invention in the event of the reciprocal upward movement (compression of the spring) and rebound of the vehicle wheels connected to one another via the device 1 according to the invention is described below.

In this example, the vehicle wheel which is connected to the vibration damper 5 located on the left in FIG. 1 is moved upwardly (compressed), with the result that the cylinder 9 is displaced relative to the piston 8 in the direction of the arrow 17. The wheel connected to the right-hand vibration damper 6 rebounds. In this case, the cylinder 9 of the vibration damper 6 is displaced with respect to the piston 8 in the direction of the arrow 19. The pressure in the lower chamber 12 of the left-hand vibration damper 5 rises, with the result that the hydraulic fluid flows via the line 15 into the chamber 28 of the balancing device 20.

However, as the vehicle wheel assigned to the right-hand vibration damper 6 moves downwardly, the cylinder 9 is displaced in the direction indicated by the arrow 19, the pressure in the upper chamber 11 of the vibration damper 6 rises and the pressure in the lower chamber 12 decreases. In addition to an overflow of hydraulic fluid out of the upper chamber 11 into the lower chamber 12 via the bores 13 and the valves 14 in the piston 8 which is caused by the vacuum in the lower chamber 12, hydraulic fluid also flows out of the third chamber 29 of the balancing device 20 into the lower chamber 12 of the vibration damper 6 via the line 16.

A pressure difference thus prevails in the balancing device 20 at the second separating piston 27. There is an increased pressure in the second chamber 28 whereas a reduced pressure develops in the third chamber 29. This pressure difference also prevails in the bypass chamber 43 via the lines 41, 42, the result of this being that the pressure difference piston 44 is pressed downward in the bypass chamber 43 until it comes, with the damping element 45 fastened on the surface, to bear against the end wall 46 of the bypass chamber 43.

If the pressure gradient between the second chamber 28 and the third chamber 29 is not yet balanced as a result of the displacement of the pressure difference piston 44, hydraulic fluid flows through the bore 31 and at the same time presses the spring assembly 32 away from the second separating piston 27, thus providing a gap, through which the hydraulic fluid flows, in a throttled manner, from the second chamber 28 into the third chamber 29. The damping action by means of the bores 30, 31 and the valves 32, 33 in the second separating piston 27 therefore commences only in the event of pronounced relative displacements in the vibration dampers 5, 6. This increases driving comfort, particularly when the vehicle drives on one side over a small obstacle, for example a manhole cover.

Owing to the geometric configuration and/or material composition of the damping element 45 fastened to the end faces of the pressure difference piston 44, the transition of the damping brought about by the bypass 40 to the damping caused by the bores 30, 31 and valves 32, 33 in the balancing device 20 can be influenced. For example, the damping element 45 may be designed annularly with a semicircular or triangular cross section. Owing, for example, to the geometric configuration of the damping element 45 or of the end walls 46, 47, a “vacuum sticking” of the pressure difference piston 44 to the end walls 46, 47 can also be prevented.

By the size of the bypass chamber 43, in particular, the compression or rebound travel of a wheel, beyond which damping commences in the balancing device 20, can be adjusted.

If the bypass has a variable throttle 51, for example a proportional valve, instead of the pressure difference piston 44 arranged in the bypass chamber 43, then this can be activated, for example, as a function of the vehicle speed and/or the relative displacement of the pistons 8 in the cylinders 9 of the vibration dampers 5, 6. The sensors necessary for this purpose, however, are not illustrated in the drawing. The same action can thus be achieved by means of the adjustable throttle 51 as by means of the pressure difference piston 44, but the hydraulic volume to be displaced before the throttling by means of the bores 30, 31 and valves 32, 33 in the second separating piston 27 comes into effect can be adjusted.

What is claimed is:

1. A device (1) for damping pitching movements of a vehicle body, with
two hydraulic vibration dampers (5, 6) which are assigned to two vehicle wheels running in different tracks, said device comprising:
a balancing structure (20) which is connected to the vibration dampers (5, 6) via hydraulic lines (15, 16),
the balancing structure (20) having various chambers (24, 28, 29) of variable size and a first separating piston (25) delimiting a first chamber (24) filled with compressible medium,
a second and a third chamber (28, 29) each filled with hydraulic fluid and connected to one and respectively the other of the vibration dampers (5, 6) via one of the hydraulic lines (15, 16),
a valve (32; 33) arranged at respective bores (30, 31) extending between the second and the third chamber (28, 29) via which the two chambers (28, 29) can communicate with one another, and, parallel to the bores (30, 31), a bypass (40; 50) connecting the second and the third chamber (28, 29) to one another,
the first separating piston (25) abutting a piston rod (26), which is connected to a second separating piston (27), which includes the passages (30, 31) in the valve (32, 33) and which delimits the second and the third chambers (28, 29), said bypass (40, 50) extending within one of the piston rod (26) and the second separating piston (27).

2. The device as claimed in claim 1, wherein the bypass (40, 50) has a throttle structure (51).

3. The device as claimed in claim 2, wherein the flow cross-section through the throttle structure (51) is controllable.

4. The device as claimed in claim 1, wherein a differential pressure piston (44) is arranged axially movably in the bypass (40).

5. The device as claimed in claim 4, wherein the piston rod (26) comprises at least two parts (26a, 26b), the differential pressure piston (44) being movably supported in a recess (43) of that part (46b) of the piston rod (26) on which the second separating piston (27) is held.

6. The device as claimed in claim 1, wherein the second separating piston (27) is at least partially held axially displaceably on the piston rod (26).

7. The device as claimed in claim 6, wherein a damping structure (45) is provided between at least one of the differential pressure piston (44) and the second separating piston (27) and a respective mechanical stop (35, 36), of the piston rod (26).
